(19) United States
(12) Patent Application Publication
(10) Pub. No.: US 2005/0257223 A1
(43) Pub. Date: Nov. 17, 2005

(54) Method, system, and computer program product for returning constant values as per-process variables

(75) Inventor: Julianne Frances Haugh, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/844,630

(22) Filed: May 13, 2004

(51) Int. Cl. G06F 9/46

(52) U.S. Cl. 719/310

(57) ABSTRACT

A method, computer program product, and a data processing system for providing return values to a requesting process is provided. A plurality of datums having respective standard-based datum values are stored in a datum store. A variant datum value associated with both one or more of the plurality of datums and a first process are stored in a process-specific datum store. A request for a standard-based datum value is received from the first process. The variant datum value is returned as the standard-based datum to the first process.

### BACKGROUND OF THE INVENTION

1. Technical Field

The present invention relates generally to an improved data processing system and in particular to a method and data processing system for returning values on a per-process basis. Still more particularly, the present invention provides a method and data processing system for returning standards-based constant values as variable values on a per-process basis.

2. Description of Related Art

An operating system running on a data processing system utilizes configuration parameters that describe or control behavior of the data processing system or the operating system. For example, limitations on the size of an object, mechanisms by which the object may be accessed or other descriptive values may be defined by configuration parameters accessed by the operating system.

Many configuration values accessed by a standardized system process implementation are considered to be constants. In such situations, the ability to alter the configuration value is problematic. For example, providing backwards compatibility with previous operating system releases may not be possible with some processes due to standards-constrained configuration parameter values passed between the operating system and processes.

Thus, it would be advantageous to provide a mechanism for modifying a configuration value on a per-process basis. It would be further advantageous to provide a method and data processing system for modifying a configuration parameter having a standard-based attribute or value on a per-process basis. It would be further advantageous to modify a standard-based configuration parameter in a manner that does not violate requirements of a software implementation that operates in compliance with the standardized specification.

### SUMMARY OF THE INVENTION

The present invention provides a method, computer program product, and a data processing system for providing return values to a requesting process. A plurality of datums having respective standard-based datum values are stored in a datum store. A variant datum value associated with both one or more of the plurality of datums and a first process are stored in a process-specific datum store. A request for a standard-based datum value is received from the first process. The variant datum value is returned as the standard-based datum to the first process.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in which a preferred embodiment of the present invention may be implemented;

FIG. 3 is a block diagram illustrating a data processing system implemented as a client in the network described with reference to FIG. 1;

FIG. 4 is a diagrammatic illustration of an exemplary process and operating system interface as is conventional and in which an implementation of the present invention may be deployed for advantage;

FIG. 5 is a diagrammatic illustration of a table comprising a plurality of records and fields for storing standard-based datum values in accordance with a preferred embodiment of the present invention;

FIG. 6 is a diagrammatic illustration of an exemplary process and operating system interface implementation according to a preferred embodiment of the present invention;

FIGS. 7A and 7B are exemplary implementations of a process-specific datum store and a process-specific saved datum store implemented as respective tables in accordance with a preferred embodiment of the present invention; and

FIG. 8 is a flowchart of a return value routine processing performed for returning standard-based constant datum values as per-process variable datum values in accordance with a preferred embodiment of the present invention.

### DETAILED DESCRIPTION OF THE PREFERRED EMBODIMENT

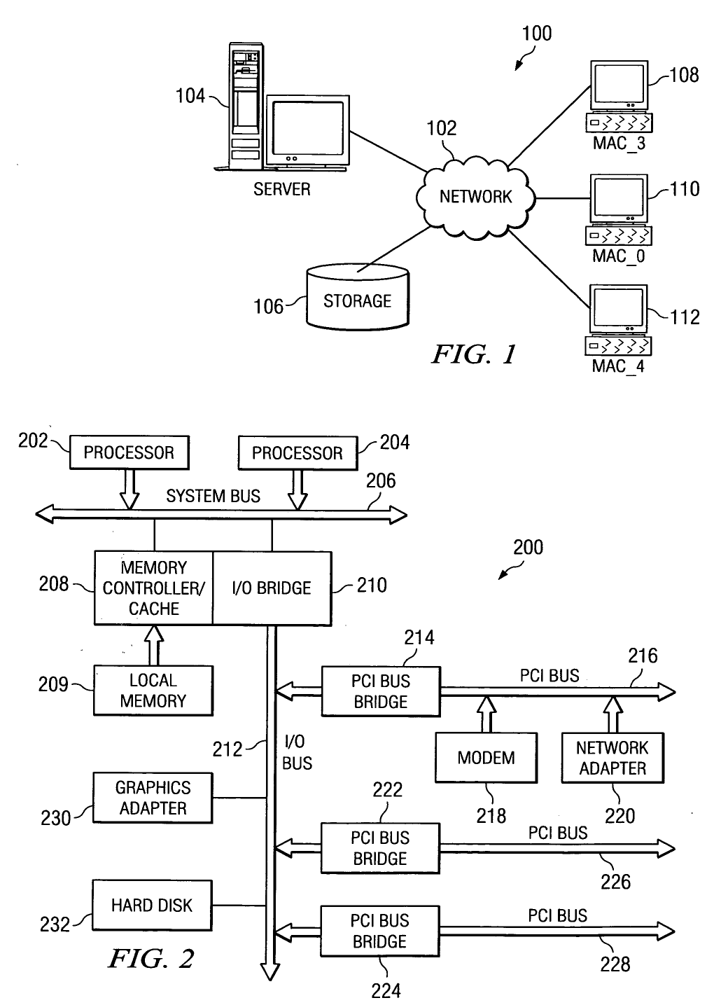

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications or processes to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

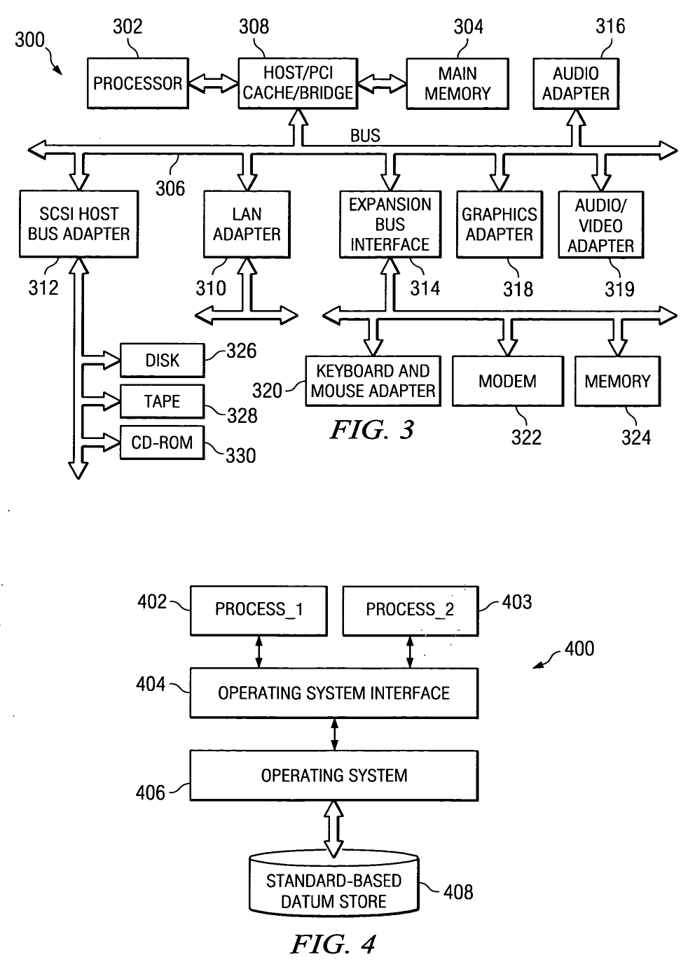

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or processes executing on data processing system 300. “Java” is a trademark of Sun Microsystems, Inc. Instructions for the operating system, the object-oriented programming system, and processes or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a diagrammatic illustration of an exemplary process and operating system interface as is conventional and in which an implementation of the present invention may be deployed for advantage. Processes 402 and 403 (illustratively designated as Process_{—}1 and Process_{—}2, respectively) communicate with operating system 406 by way of operating system (O/S) interface 404. For example, O/S interface 404 may be implemented as a system call interface, a shared library function call, or the like. Operating system 406 may be implemented as an instance of the AIX operating system, another variant of the Unix operating system, or another suitable operating system.

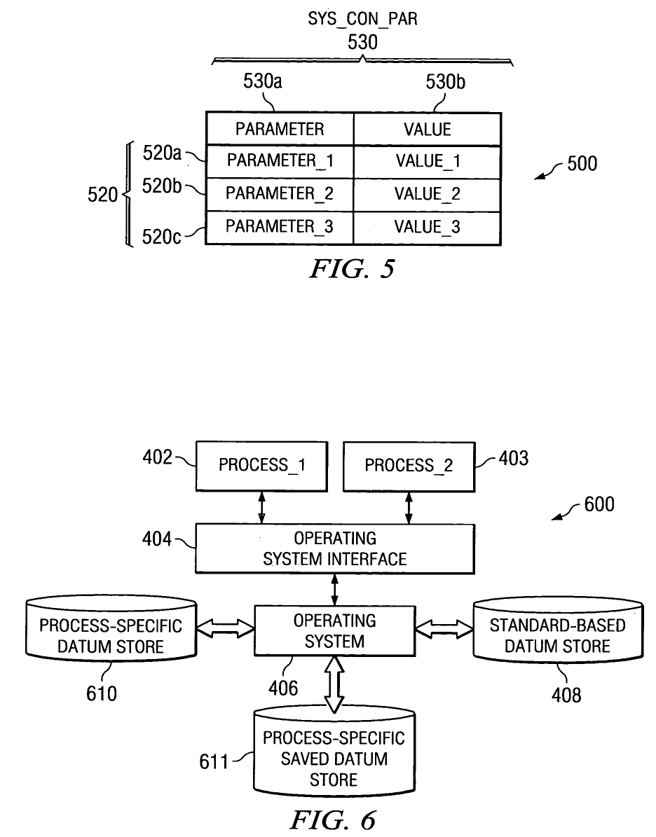

Operating system 406 accesses configuration parameters or other standard-based data maintained in standard-based datum store 408 that maintains system configuration information. For example, standard-based datum store 408 may maintain a configuration file that is queried at the time a process, such as process 402, is initialized, a configuration parameter database that maintains configuration parameters on a per-user basis that are applied to all processes initiated by a particular user, or the like. Standard-based datum store 408 may be implemented, for example, as a table or other data structure for storing static or constant system configuration values. FIG. 5 is a diagrammatic illustration of a table 500 comprising a plurality of records 520 and fields 530 for storing configuration parameters. Table 500 is an example of standard-based datum store 408 shown in FIG. 4. Table 500 may be stored in local memory 209 and processed by processor 202 or 204 of data processing system 200 shown in FIG. 2.

Each record 520a-520c, or row, comprises data elements in respective fields 530a-530b. Table 500 has a label, or identifier, assigned thereto. In the present example, table 500 has a label of “SYS_CON_PAR.” Each of fields 530a and 530b have a respective label, or identifier, that facilitates insertion, deletion, querying, or other data operations or manipulations of table 500. In the illustrative example, fields 530a and 530b have respective labels of “Parameter” and “Value.” A particular field, e.g., field 530a, may be designated as a key field and each respective data element is unique within key field 530a. Assignment of unique values to data elements of key field 530a provides an identifier for records 520a-520c and the collection of data elements of key field 530a is typically referred to as an index. Addressing a particular record 520a-520c via an associated data element of key field 530a is referred to as indexing of record 520a-520c. Alternatively, a key may be obtained by a function, e.g., a hashing function, that indexes a particular record 520a-520c.

In the illustrative example, key field 530a comprises configuration parameter names for indexing records 520a-520c. Field 530b may store, for example, integer values that specify a maximum allowed data value of a corresponding configuration parameter specified by a parameter name defined in field 530a of a common record within table 500. In the illustrative example, assume data elements stored in value field 530b are standards-based configuration parameter values of a corresponding configuration parameter defined by parameter field 530a.

Processes 402 and 403 may issue requests to O/S 406 for a configuration parameter by issuing a call to O/S interface 404. The call is passed to O/S 406 that, responsive to interrogating standard-based datum store 408, returns the requested value to the requesting process.

FIG. 6 is a diagrammatic illustration of an exemplary process and operating system interface implementation according to a preferred embodiment of the present invention. Processes 402 and 403 communicate with operating system 406 by way of O/S interface 404. For example, O/S interface 404 may comprise a sysconf subroutine available in the AIX operating system or other Unix operating system variant. Operating system 406 may access standard-based datum store 408, process-specific datum store 610 and process-specific saved datum store 611 that each maintain system configuration parameters. Process-specific datum store 610 and process-specific saved datum store 611 may be implemented as respective tables or other suitable data structures.

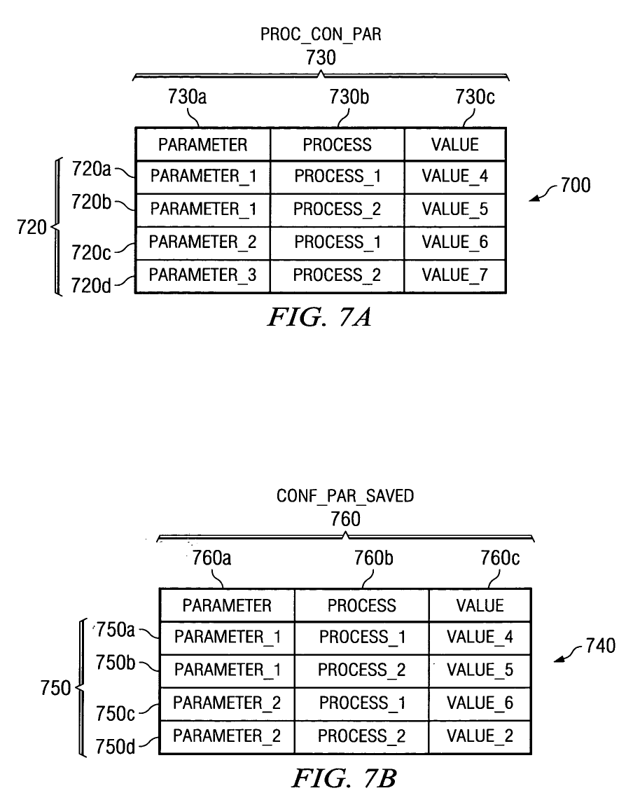

FIGS. 7A and 7B are respective exemplary implementations of process-specific datum store 610 and process-specific saved datum store 611 implemented as respective tables 700 and 740 in accordance with a preferred embodiment of the present invention. Table 700 comprises a plurality of records 720 and fields 730 for storing process-specific configuration parameters. Table 700 has a label of “PROC_CON_PAR.” Fields 730a-730b have respective labels of “Parameter,” “Process,” and “Value.” Field 730a stores parameter names, e.g. a string value specifying a configuration parameter. Field 730b stores a process identifier, e.g., Process_{—}1 or Process_{—}2, and field 730c stores a configuration parameter value of the configuration parameter identified in field 730a of a common record. In this manner, a datum value, e.g., “Value_{—}4” stored in field 730c of record 720a of a particular datum (Parameter_{—}1), is associated with a particular process, e.g., “Process_{—}1.” Moreover, different datum values may be stored for different processes that interface with O/S 406 thereby facilitating return of datum values that are variants of a corresponding standard-based datum value.

In accordance with a preferred embodiment of the present invention, one or more records, e.g., records 720a and 720b, provide a configuration parameter value variant associated with a standard-based configuration parameter value stored in a record, e.g., record 520a, of table 500. For example, record 520a of table 500 defines a standard-based configuration parameter value (Value_{—}1) for a configuration parameter (Parameter_{—}1) in field 530b. The configuration parameter value stored in field 530b of table 500 is a standard-based configuration value that is used by O/S 406 on a system-wide basis unless an alternative, or variant, process-specific configuration parameter corresponding to the configuration parameter is specified in table 700. In the illustrative example, records 720a and 720b each respectively define a variant value for the system-wide, standard-based configuration parameter value defined in record 520a of table 500. Particularly, record 720a defines, in association with a process (Process_{—}1), a variant value (Value_{—}4) of a datum (Parameter_{—}1) having a standard-based value (Value_{—}1) defined in record 520a of standard-based datum store 408. Likewise, record 720b defines a variant value (Value_{—}5), in association with a different process (Process_{—}2), of the datum (Parameter_{—}1) having a standard-based value (Value_{—}1) defined in record 520a of standard-based datum store 408.

In a similar manner, table 740 is an exemplary data structure for storing process-specific configuration parameter values that have been previously returned to a requesting process. Table 740 comprises records 750 and fields 760. Table 740 has a label of “CONF_PAR_SAVED” and fields 760a-760c have respective labels of “Parameter,” “Process,” and “Value”. Records 750a-750d of table 740 store configuration parameter values in field 760c in association with an process that have previously been returned to a requesting process identified in field 760b for a configuration parameter or other datum specified by field 760a. Thus, table 740 is representative of process-specific saved datum store 611 after request of datums Parameter_{—}1 and Parameter_{—}2 by process 402 and request of datums Parameter_{—}1 and Parameter_{—}2 by process 403.

Processes 402 and 403 may issue requests to O/S 406 for a configuration parameter by issuing a call to O/S interface 404, and the call is passed to O/S 406. In accordance with a preferred embodiment of the present invention, O/S 406 interrogates process-specific saved datum store 611 to determine if a datum variant for the datum requested by the process has previously been returned. If no datum variant has previously been requested by the requesting process, both the standard-based datum store 408 and process-specific datum store 610 are interrogated for the requested datum. An evaluation of any retrieved process-specific datum obtained from process-specific datum store 610 is preferably made to determine if the datum variant is valid. If a valid datum variant is identified, the datum variant is returned to the requesting process and is stored in process-specific saved datum store 611. Alternatively, the standard-based datum value retrieved from standard-based datum store 408 is returned to the requesting process.

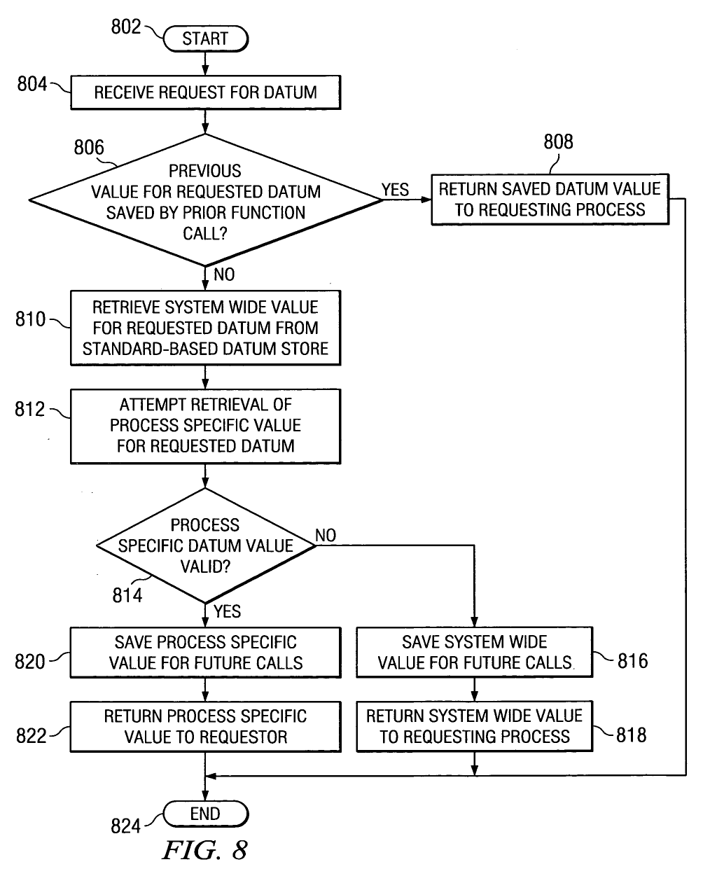

FIG. 8 is a flowchart of a return value routine processing performed for returning constant standard-based datum values as process-specific variable datum values in accordance with a preferred embodiment of the present invention. The return value routine is initialized (step 802), for example on boot of data processing system 200. The return value routine then awaits receipt of a request for a datum such as a request for a system configuration parameter. On receipt of a request issued by a process (step 804), e.g., process 402 of FIG. 6, the return value routine evaluates whether the requested datum has been previously returned to the requesting process (step 806). For example, the return value routine may interrogate process-specific saved datum store 611 using an identifier of the requested datum, e.g., a configuration parameter name, as an interrogation operand. Additionally, the return value routine may use a process identifier for interrogation of process-specific saved datum store 611. If an evaluation is made that the requested datum is maintained in process-specific saved datum store 611, the return value routine proceeds to return the value of the requested datum retrieved from process-specific saved datum store 611 to the requesting process (step 808). After return of the requested datum, the return value routine cycle ends (step 824).

Returning again to step 806, the return value routine proceeds to retrieve the system-wide datum requested in the event that the requested datum is not maintained in process-specific saved datum store 611 (step 810). For example, the return value routine may interrogate standard-based datum store 408 for the requested datum. Additionally, the return value routine attempts to retrieve a process-specific datum value of the requested datum, for example by interrogation of process-specific datum store 610 (step 812). An evaluation of any process-specific datum value returned from process-specific datum store 610 may be made to determine if the process-specific datum value is valid (step 814). For example, the process-specific datum value may be compared to a minimum allowed value and the value specified by the datum value retrieved from standard-based datum store 408. If the process-specific datum value is evaluated as valid, the return value routine saves the process-specific datum value for future process requests, for example by storing the process-specific datum value in process-specific datum store 610 (step 820). The process-specific datum value is then returned to the requesting process (step 822), and the return value routine cycle ends according to step 824.

In the event that the process-specific datum value is determined to be invalid, or alternatively in the event that no process-specific datum value is obtained at step 812, the return value routine proceeds to save the system-wide datum value obtained from standard-based datum store 408 in process-specific saved datum store 611 (step 816). The return value routine then returns the datum value obtained from standard-based datum store 408 to the requesting process (step 818), and the return value routine cycle then ends in accordance with step 824.

Thus, a mechanism for modifying a configuration parameter or other standard-based datum value on a per-process basis is provided by the present invention. A system datum having a standard-based value is available on a system-wide basis as a constant value. Variants of the standard-based value are available on a per-process basis. Thus, an operating system may interface with processes requesting datums that have constant values in conformance with a standard and may return variants of the standard values on a per-process basis.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for providing return values to a requesting process, the method comprising the computer implemented steps of:
storing a plurality of datums having respective standard-based datum values in a datum store;
storing a variant datum value associated with both one or more of the plurality of datums and a first process in a process-specific datum store;
receiving a request for a standard-based datum value from the first process; and
returning the variant datum value as the standard-based datum value to the first process.

2. The method of claim 1, further comprising:
interrogating the process-specific datum store with an identifier of the first process.

3. The method of claim 1, further comprising:
interrogating the process-specific datum store with an identifier of the requested standard-based datum value.

4. The method of claim 1, further comprising:
storing, responsive to returning the variant datum value, the variant datum value in a saved datum store; and
responsive to a subsequent request for the standard-based datum value, retrieving the variant datum value from the saved datum store.

5. The method of claim 1, further comprising:
receiving a request for the standard-based datum value from a second process;
interrogating the process-specific datum store for a variant datum value of the standard-based datum value;
determining that a variant datum value associated with the second process is not stored in the process-specific datum store;
retrieving the requested standard-based datum value from the datum store; and
returning the standard-based datum value retrieved from the datum store to the second process.

6. The method of claim 1, wherein the steps of receiving and returning are performed by an operating system.

7. A computer program product in a computer readable medium for processing a request for a configuration parameter:
first instructions for receiving a request for a standard-based datum value;
second instructions, responsive to receipt of the request, that interrogate a standard-based datum store maintaining a plurality of standard-based datum values and a process-specific datum store for maintaining at least one variant datum value in association with both one or more of the plurality of standard-based datum values and a first process; and
responsive to the interrogation by the second instructions, third instructions for retrieving a first variant datum value from the process-specific datum store.

8. The computer program product of claim 7, further comprising:
fourth instructions that return the first variant datum value as the standard-based datum value to the first process, wherein the first process issued the request.

9. The computer program product of claim 8, wherein the first process is identified as associated with the first variant datum value.

10. The computer program product of claim 8, further comprising:
fifth instructions that write the first variant datum value to a third store.

11. The computer program product of claim 7, further comprising:
fourth instructions that evaluate the first variant datum value for validity.

12. The computer program product of claim 11, wherein the fourth instructions compare the first variant datum value with the associated one or more of the plurality of the standard-based datum values.

13. The computer program product of claim 7, wherein the standard-based datum store and the process-specific datum store are implemented as table data structures.

14. The computer program product of claim 13, wherein the process-specific datum store maintains a plurality of variant datum values each associated with a datum identifier and a process.

15. The computer program product of claim 14, wherein each of the plurality of variant datum values are associated with one of the plurality of standard-based datum values, wherein each variant datum value differs from the associated standard-based datum value.

16. A data processing system comprising:
a memory that contains a set of instructions; and
a processing unit, responsive to execution of the set of instructions, for receiving a request from a first process for a standard-based datum value, interrogating a standard-based datum store and a process-specific datum store, and returning a variant datum value obtained from the process-specific datum store as the standard-based datum value to the first process.

17. The data processing system of claim 16, wherein the processing unit interrogates the process-specific datum store with an identifier of the first process and an identifier of the standard-based datum value requested by the first process.

18. The data processing system of claim 16, wherein the process-specific datum store and the standard-based datum store are implemented as table data structures maintained in the memory.

19. The data processing system of claim 16, wherein the processing unit receives a request from a second process for the standard-based datum value, and wherein the processing unit, responsive to interrogating the process-specific datum store, returns the standard-based datum value retrieved from the standard-based datum store to the second process.

20. The data processing system of claim 19, wherein the process-specific datum store does not contain a datum value variant associated with the second process for the standard-based datum value.
